(19) United States
(12) Patent Application Publication
(10) Pub. No.: US 2013/0262818 A1
(43) Pub. Date: Oct. 3, 2013

(54) DNA COMPUTING

(71) Applicant: David Bobbak Zakariaie, Los Angeles, CA (US)

(72) Inventor: David Bobbak Zakariaie, Los Angeles, CA (US)

(21) Appl. No.: 13/850,177

(22) Filed: Mar. 25, 2013

Related U.S. Application Data
(60) Provisional application No. 61/617,026, filed on Mar. 28, 2012.

(51) Int. Cl. G06F 15/78

(52) U.S. Cl. CPC G06F 15/78
USPC 712/32

(57) ABSTRACT

This invention deals generally with DNA-based microprocessors. In an exemplary embodiment of the invention, a DNA lattice or grid with photoreceptors forms a microprocessor and is configured to perform the functions of a series of logic gates. An input signal is supplied to the DNA lattice by shining a light signal on the lattice. The lattice performs the functions of the series of logic gates that are placed on the lattice. The lattice, in turn, supplies an augmented light output signal, which is decoded to reflect the processing by the DNA-based microprocessor.

### CROSS REFERENCE TO RELATED APPLICATIONS

This application claims priority to provisional patent application number 61/617,026 filed on Mar. 28, 2012, the contents of which are fully incorporated herein with this reference.

### FIELD OF THE INVENTION

The present invention generally relates to microprocessors and their components and constituents. More particularly, the present invention relates to a processor that operates on DNA activated from receiving input in the form of light signals or DNA-nucleotide stands.

### BACKGROUND OF THE INVENTION

The central processing unit (CPU) is the portion of a computer system that carries out the instructions of a computer program, to perform the basic arithmetical, logical, and input/output operations of the system. The CPU plays a role somewhat analogous to the brain in the computer. The form, design and implementation of CPUs have changed dramatically since the earliest examples, but their fundamental operation remains much the same.

On large machines, CPUs require one or more printed circuit boards. On personal computers and small workstations, the CPU is housed in a single silicon chip called a microprocessor. Since the 1970s the microprocessor class of CPUs has almost completely overtaken all other CPU implementations. Modern CPUs are large scale integrated circuits in packages typically less than four centimeters square, with hundreds of connecting pins.

Two typical components of a CPU are the arithmetic logic unit (ALU), which performs arithmetic and logical operations, and the control unit (CU), which extracts instructions from memory and decodes and executes them, calling on the ALU when necessary.

Early CPUs were custom-designed as a part of a larger, sometimes one-of-a-kind, computer. However, this method of designing custom CPUs for a particular application has largely given way to the development of mass-produced standardized processors. This standardization began in the era of discrete transistor mainframes and minicomputers and has rapidly accelerated with the popularization of the integrated circuit (IC). The IC has allowed increasingly complex CPUs to be designed and manufactured to tolerances on the order of nanometers. Both the miniaturization and standardization of CPUs have increased the presence of digital devices in modern life far beyond the limited application of dedicated computing machines. Modern microprocessors appear in everything from automobiles to cell phones and children's toys.

The design complexity of CPUs increased as various technologies facilitated building smaller and more reliable electronic devices. The first such improvement came with the advent of the transistor. Transistorized CPUs during the 1950s and 1960s no longer had to be built out of bulky, unreliable, and fragile switching elements like vacuum tubes and electrical relays. With this improvement more complex and reliable CPUs were built onto one or several printed circuit boards, which contain discrete (individual) components.

During this period, a method of manufacturing many transistors in a compact space gained popularity. The integrated circuit (IC) allowed a large number of transistors to be manufactured on a single semiconductor-based die, or “chip.” At first only very basic non-specialized digital circuits such as NOR gates were miniaturized into ICs. CPUs based upon these “building block” ICs are generally referred to as “small-scale integration” (SSI) devices. SSI ICs, such as the ones used in the Apollo guidance computer, usually contained up to a few dozen transistors. To build an entire CPU out of SSI ICs required thousands of individual chips, but still consumed much less space and power than earlier discrete transistor designs. As microelectronic technology advanced, an increasing number of transistors were placed on ICs, thus decreasing the quantity of individual ICs needed for a complete CPU. MSI and LSI (medium- and large-scale integration) ICs increased transistor counts to hundreds, and then thousands.

While the complexity, size, construction, and general form of CPUs have changed drastically over the past sixty years, it is notable that the basic design and function has not changed much at all. Concerns have arisen about the limits of integrated circuit transistor technology and the use of silicon as the base of the computer chip. Extreme miniaturization of electronic gates is causing the effects of phenomena like electromigration, overheating, and subthreshold leakage to become much more significant. Computer chip developers are concerned that silicon is reaching its limitations as the primary material for manufacturing of computer chips. These newer concerns are among the many factors causing researchers to investigate new methods of computing such as the quantum computer, as well as to expand the use of parallelism and other methods that extend the usefulness of the classical von Neumann model.

Accordingly, there is a need to replace the silicon based transistor chip with a new microprocessor that is smaller, can handle more complex tasks, and works faster. The present invention fulfills these needs and provides other related advantages.

### SUMMARY OF THE INVENTION

An exemplary embodiment of the present invention includes a DNA-based microprocessor having a plurality of DNA-transistors arranged relative to one another or bonded to one another in a grid-like assembly. Each of the plurality of DNA-transistors are comprised of a plurality of DNA-molecules configured in specific amino-acid sequences thereby replicating logic gates. The grid-like assembly is configured to receive an input signal of a pulsed electromagnetic wave. The input signal includes a first modulated data signal. The grid-like assembly is configured to, following the absorption of the first modulated data signal, emit an output signal of an electromagnetic wave comprising a second modulated data signal. The second modulated data signal is an augmentation of the first modulated data signal based upon computing operations performed by the plurality of DNA-molecules.

In other exemplary embodiments, the input signal of the first modulated data signal may be based upon a quaternary numeral system. Or, the input signal of the first modulated data signal may be based upon a binary numeral system. Alternatively, the input signal of the first modulated data signal may be converted from a binary signal to a quaternary numerical system prior to being input into the DNA-based microprocessor.

The logic gates or DNA-transistors may include a combination of one or more following transistor types: AND, OR, NOT, NAND, NOR, XOR or XNOR.

The input signal may include more than one electromagnetic wave. The output signal may include more than one electromagnetic wave. The more than one electromagnetic wave may include more than one different frequency. The one different frequency may then allow the DNA-based microprocessor to simultaneously process multiple sequences of data.

Another exemplary embodiment of the present invention includes a DNA-based transistor having a plurality of DNA-molecules configured in specific amino-acid sequences thereby replicating a logic gate. The DNA-based transistor is configured to receive an input signal of a pulsed electromagnetic wave. The DNA-based transistor is configured to perform a computing operation to the input signal creating an output signal. The DNA-based transistor is configured to emit the output signal as an augmented pulsed electromagnetic wave.

In other exemplary embodiments, the input signal may based upon a quaternary numeral system or a binary numeral system. The input signal may include a binary signal converted to a quaternary numerical signal prior to being input into the DNA-based transistor.

The DNA-transistors may include a combination of one or more following transistor types: AND, OR, NOT, NAND, NOR, XOR or XNOR.

The input signal may include a plurality of pulsed electromagnetic waves or the output signal comprises a plurality of augmented pulsed electromagnetic waves.

The input signal may include more than one pulsed electromagnetic wave comprising at least two different frequencies, thereby allowing the DNA-based transistor to simultaneously process multiple sequences of data.

Another exemplary embodiment of the present invention includes a DNA-based microprocessor having a plurality of enzymatic-transistors arranged relative to one another or bonded to one another in a grid-like assembly. Each of the plurality of enzymatic-transistors include of a plurality of restriction enzymes configured in specific amino-acid sequences thereby replicating logic gates. The grid-like assembly is configured to receive an input signal of a pulsed electromagnetic wave. The input signal includes a first modulated data signal. The grid-like assembly is configured to, following the absorption of the first modulated data signal, emit an output signal of an electromagnetic wave comprising a second modulated data signal. The second modulated data signal is an augmentation of the first modulated data signal based upon computing operations performed by the plurality of restriction enzymes.

In other exemplary embodiments, the input signal is based upon a quaternary numeral system or a binary numeral system. The input signal may include a binary signal converted to a quaternary numerical signal prior to being input into the DNA-based microprocessor.

The DNA-transistors may include a combination of one or more following transistor types: AND, OR, NOT, NAND, NOR, XOR or XNOR.

The input signal may include more than one pulsed electromagnetic wave having at least two different frequencies, thereby allowing the DNA-based transistor to simultaneously process multiple sequences of data.

### DETAILED DESCRIPTION OF THE PREFERRED EMBODIMENTS

An integrated circuit or monolithic integrated circuit (also referred to as IC, chip, or microchip) is an electronic circuit manufactured by the patterned diffusion of trace elements into the surface of a thin substrate of semiconductor material. Additional materials are deposited and patterned to form interconnections between semiconductor devices. Integrated circuits are used in virtually all electronic equipment today and have revolutionized the world of electronics. Computers, mobile phones, and other digital appliances are now inextricable parts of the structure of modern societies, made possible by the low cost of production of integrated circuits.

The present invention uses DNA as the basis of the microprocessor as compared to the prior art silicon-based microchip technologies. As is known in the art, certain configurations of DNA nucleotides perform functions that are analogous to one or more of the traditional logic gates (AND, OR, NOT, NAND, NOR, XOR and XNOR). Such logic gates, when comprised of DNA, may be referred to as DNA-Transistors and/or Enzymatic Transistors.

DNA may be configured by machine placement of individual molecules into a lattice. DNA may likewise be configured by movement using a microscope or other methods known in the art. In one exemplary embodiments of the present invention, the DNA molecules are configured into a lattice shaped structure or grid-like assembly. It is postulated that DNA may be configured into innumerable other structure shapes. Multiple DNA-Transistors may be arranged relative to one another or bonded to one another to form the lattice or grid-like assembly.

In an exemplary embodiment, individual DNA-based logic gates are configured into a lattice in order to combine logic gates in a manner analogous to how transistors are combined to form a microprocessor.

DNA provides innumerable advantages over the prior art silicon-based microchip technologies and addresses many of the shortcomings of silicon noted above. DNA is smaller and faster than the silicon-based computer technologies. 10 trillion DNA molecules can fit in area no larger than one cubic centimeter. DNA is in abundance, non-toxic and cheap when compared to silicon-based computing. Instead of using a silicon processor that processes information by using electricity, the DNA molecules may process signals conveyed by light, DNA-strands, or other forms of input/output. DNA may be mixed with photoreceptors, making it light sensitive. In this manner, logic gates transmitting light instead of electricity will perform significantly faster.

In certain embodiments of the present invention, the input signal may comprise more than one electromagnetic wave. In such instances, the multiple electromagnetic waves may be processed simultaneously (in a manner analogous to quantum computing) such that more efficient computing is achieved. Such multiple waves may control varying energy levels of the various DNA sequences.

The manner in which the DNA-based processor of the present invention operates differs from the traditional computer processor. Unlike the traditional computer processor where it just has two states, on and off or 0 and 1, the present invention uses the DNA nucleotides to represent four different states. The four states are A,T,C,G which correlate with the first letter of each nucleotide: A=Adenine, T=Thymine, C=Cytosine, and G=Guanine. Such four-state systems are commonly referred to as quaternary numeral systems. The DNA-processed microprocessor may likewise be used with binary numeral systems and other systems known in the art. In certain embodiments, a binary signal is converted to a quaternary numeral system prior to being input to the DNA-based microprocessor.

When a string of data is entered by an operator into a computer to be processed, traditionally it will be translated into machine code which is also known as binary. Binary as noted above is the standard machine code and is composed of zeros and ones.

In an exemplary embodiment of the present invention, rather than binary, the machine code processed by the DNA-based processor is ATCG. The sequence of A,T,C, and G are processed according to the following procedure: First, an operator inputs a string of data to a computer. The computer translates the data string into ATCG computer code. The ATCG is translated into a light pulse and an ultra violet light flashes in certain patterns which correlate the sequence of the machine code which from here on is a sequence of A, T, C, and G. The light pulse is transmitted onto the DNA processor lattice.

The first logic gate or DNA-Transistor on the lattice absorbs light energy and emits a modified light signal. The light signal is absorbed and re-emitted by all of the logic gates or DNA Transistors contained on the lattice. A modified light signal is emitted by the last logic gate on the lattice. Emitted light signal is received by the photo-sensor and the signal from the photo-sensor is decoded by the computer. The computer translates the output machine into the solution to the data string input. The emitted light signal or output signal comprises an augmentation of the input signal's modulated data signal based upon the computing operations performed by the DNA-Transistors on the input signal.

In another exemplary embodiment of the present invention, inputs and outputs occur using signals that are modulated onto strands of DNA. In such embodiments, first, an operator inputs a string of data. Next, the computer translates the data string into ATCG code. That ATCG code is synthesized into a DNA strand. The synthesized DNA strand is mated with the DNA-processor lattice. The first logic gate on the lattice mates with the DNA strand and performs PCR amplification. The DNA strand selectively passes through each logic gate until PCR amplification occurs. A modified DNA strand is discharged by the last logic gate on the lattice. The discharged DNA strand is received by a DNA sequence sensor. Signal from the DNA sequence sensor is decoded by the computer. The computer translates the output machine code into the solution to the data string input.

Calculations are performed at much faster rates because there are four states instead of two. This will allow computers to work more like the human brain, which is parallel, rather than how silicon microchips work, which is linear. Computers that run on this DNA based microprocessor will work the same way. Most humans can perform multiple tasks at the same time (i.e.: chew gum and ride a bike at the same time) and, like us, the DNA computer will be able to perform multiple tasks simultaneously. Therefore, multiple items can be calculated and processed simultaneously on the same chip.

A logic gate is an idealized or physical device implementing a Boolean function, that is, it performs a logical operation on one or more logic inputs and produces a single logic output. Logic gates are primarily implemented using diodes or transistors acting as electronic switches, but can also be constructed using electromagnetic relays (relay logic), fluidic logic, pneumatic logic, optics, molecules, or even mechanical elements.

With amplification, logic gates can be cascaded in the same way that Boolean functions can be composed, allowing the construction of a physical model of all of Boolean logic, and therefore, all of the algorithms and mathematics that can be described with Boolean logic.

There are seven types of logic gates; AND, OR, NOT, NAND, NOR, XOR and XNOR. To build a functionally complete logic system, relays, valves (vacuum tubes), or transistors can be used. The simplest family of logic gates using bipolar transistors is called resistor-transistor logic (RTL). Unlike diode logic gates, RTL gates can be cascaded indefinitely to produce more complex logic functions. These gates were used in early integrated circuits. For higher speed, the resistors used in RTL were replaced by diodes, leading to diode-transistor logic (DTL). Transistor-transistor logic (TTL) then supplanted DTL with the observation that one transistor could do the job of two diodes even more quickly, using only half the space. In virtually every type of contemporary chip implementation of digital systems, the bipolar transistors have been replaced by complementary field-effect transistors (MOSFETs) to reduce size and power consumption still further, thereby resulting in complementary metal-oxide-semiconductor (CMOS) logic.

The present invention includes a DNA lattice that forms the DNA microprocessor. The DNA microprocessor is comprised by individually placing a series of DNA molecules next to one another to form a lattice-like structure. The DNA can be placed manually with an electronic microscope. In production, the lattices would be manufactured in bulk by robotic assistance. The individual components of the lattice are DNA logic gates. A DNA logic gate is a sequence of DNA nucleotides, which perform Boolean functions in a manner analogous to transistors.

Each DNA molecule of the DNA lattice is comprised of a combination of nucleotides. In an exemplary embodiment of the present invention, the DNA molecule is comprised of six nucleotides. For instance, a six nucleotide combination could comprise Adenosine, Thymine, Cytosine, Guanine, Adenosine and Thymine (ATCGAT). While in an exemplary embodiment each DNA molecule is a combination of six nucleotides, DNA of varying combinations and sizes could be devised by one skilled in the art.

For transmitting light signals to the DNA lattice, a computer controls a micro light emitting diode (LED). The LED emits light at a specific wavelength at the DNA lattice. In an exemplary embodiment of the present invention, the wavelength of the LED is within the ultraviolet range.

The LED can be pulsed on and off as controlled by the computer in order to transmit a coded message to the DNA lattice. It is hypothesized that, when the light pulse signal hits one of the DNA molecules of the DNA lattice, the DNA receives the light pulse signal and then reemits the signal to adjacent DNA molecules. When an adjacent DNA molecule receives the light, it in turn also reemits the light. This happens until the light is passed to the closest corner of the DNA lattice. The light is then reemitted from the corner of the DNA lattice to a sensor, which is also computer controlled.

The sensor, which receives the output transmission from the DNA lattice is a light sensitive sensor programmed to decode a sequence of ATCG depending on the light signal output. The sensor registers the wavelength of the light coming from the lattice structure. The wavelength of the light coming from the lattice structure is different than the wavelength of the light sent by the LED. The difference in wavelength corresponds to the functionality of the lattice structure and its computing capability.

As detailed above, information can be coded and sent as a pulsed light signal into the DNA lattice structure. A changed light signal is omitted by the DNA lattice structure. The wavelength and other properties of the omitted signal are received and decoded.

For example, in an exemplary embodiment, a math problem (such as 5+5) may be coded onto the input pulsed light signal. The pulsed light signal is shined onto a portion of the DNA lattice structure. The DNA lattice structure is configured to perform the functions of a series of logic gates in a manner that is analogous to a microprocessor chip. After the input light signal is received, the DNA lattice structure processes the math problem coded on the light signal through the DNA-based logic gates in a matter analogous to the microprocessor's handling of a binary coded math problem. The DNA lattice structure, then, emits an augmented light signal as output. The output light signal may be received and decoded in order to obtain the answer to the math problem; for example 10.

It should be noted that the foregoing example of 5+5 is presented solely for the purposes of illustrating a simple mathematical function. As noted above, with amplification, logic gates can be cascaded in the same way that Boolean functions can be composed, allowing the construction of a physical model of all of Boolean logic, and therefore, all of the algorithms and mathematics that can be described with Boolean logic.

Light is faster than electrons moving along silicon. Furthermore, lattices of DNA can effectively pack more processing into a smaller area than silicon based chips ever could. Thus, as can be appreciated by one skilled in the art, the forgoing example may be scaled up tremendously in order to perform sophisticated mathematical and computing functions.

One exemplary embodiment of the present invention significantly improves upon prior art processors by allowing DNA computing in a non-binary form. Binary computers typically use two states only: on and off or 0 and 1. While prior-art processors have typically operated using a binary digital format, an exemplary embodiment of the present invention may use the four DNA nucleotides (Adenosine, Thymine, Cytosine, and Guanine) in order to achieve four states. In this manner, this embodiment of the present invention significantly improves upon prior art processors by allowing computer to operate in a greater number of states than two. In this manner, the present invention may allow DNA computing to achieve many of the benefits of quantum computing.

Although several embodiments have been described in detail for purposes of illustration, various modifications may be made to each without departing from the scope and spirit of the invention. Accordingly, the invention is not to be limited, except as by the appended claims. Other features and advantages of the present invention will become apparent from the detailed description which illustrates, by way of example, the principles of the invention.

What is claimed is:

1. A DNA-based microprocessor, comprising:
a plurality of DNA-transistors arranged relative to one another or bonded to one another in a grid-like assembly;
wherein each of the plurality of DNA-transistors are comprised of a plurality of DNA-molecules configured in specific amino-acid sequences thereby replicating logic gates;
said grid-like assembly being configured to receive an input signal of a pulsed electromagnetic wave;
said input signal comprising a first modulated data signal;
said grid-like assembly being configured to, following the absorption of the first modulated data signal, emit an output signal of an electromagnetic wave comprising a second modulated data signal;
wherein the second modulated data signal is an augmentation of the first modulated data signal based upon computing operations performed by the plurality of DNA-molecules.

2. The DNA-based microprocessor of claim 1, wherein said input signal comprising the first modulated data signal is based upon a quaternary numeral system.

3. The DNA-based microprocessor of claim 1, wherein said input signal comprising the first modulated data signal is based upon a binary numeral system.

4. The DNA-based microprocessor of claim 1, wherein said input signal comprising the first modulated data signal is converted from a binary signal to a quaternary numerical system prior to being input into the DNA-based microprocessor.

5. The DNA-based microprocessor of claim 1, wherein said logic gates or DNA-transistors comprise a combination of one or more following transistor types: AND, OR, NOT, NAND, NOR, XOR or XNOR.

6. The DNA-based microprocessor of claim 1, wherein said input signal comprises more than one pulsed electromagnetic wave.

7. The DNA-based microprocessor of claim 6, wherein said output signal comprises more than one electromagnetic wave.

8. The DNA-based microprocessor of claim 6, wherein said more than one pulsed electromagnetic wave comprises more than one different frequency.

9. The DNA-based microprocessor of claim 8, wherein said more than one different frequency allows the DNA-based microprocessor to simultaneously process multiple sequences of data.

10. A DNA-based transistor, comprising:
a plurality of DNA-molecules configured in specific amino-acid sequences thereby replicating a logic gate;
wherein the DNA-based transistor is configured to receive an input signal of a pulsed electromagnetic wave;
wherein the DNA-based transistor is configured to perform a computing operation to the input signal creating an output signal; and
wherein the DNA-based transistor is configured to emit the output signal as an augmented pulsed electromagnetic wave.

11. The DNA-based transistor of claim 10, wherein said input signal is based upon a quaternary numeral system or a binary numeral system.

12. The DNA-based transistor of claim 10, wherein said input signal comprises a binary signal converted to a quaternary numerical signal prior to being input into the DNA-based transistor.

13. The DNA-based transistor of claim 10, wherein said DNA-transistors comprises a combination of one or more following transistor types: AND, OR, NOT, NAND, NOR, XOR or XNOR.

14. The DNA-based transistor of claim 10, wherein said input signal comprises a plurality of pulsed electromagnetic waves or the output signal comprises a plurality of augmented pulsed electromagnetic waves.

15. The DNA-based transistor of claim 10, wherein said input signal comprises more than one pulsed electromagnetic wave comprising at least two different frequencies, thereby allowing the DNA-based transistor to simultaneously process multiple sequences of data.

16. A DNA-based microprocessor, comprising:
a plurality of enzymatic-transistors arranged relative to one another or bonded to one another in a grid-like assembly;
wherein each of the plurality of enzymatic-transistors are comprised of a plurality of restriction enzymes configured in specific amino-acid sequences thereby replicating logic gates;
said grid-like assembly being configured to receive an input signal of a pulsed electromagnetic wave;
said input signal comprising a first modulated data signal;
said grid-like assembly being configured to, following the absorption of the first modulated data signal, emit an output signal of an electromagnetic wave comprising a second modulated data signal;
wherein the second modulated data signal is an augmentation of the first modulated data signal based upon computing operations performed by the plurality of restriction enzymes.

17. The DNA-based microprocessor of claim 16, wherein said input signal is based upon a quaternary numeral system or a binary numeral system.

18. The DNA-based microprocessor of claim 16, wherein said input signal comprises a binary signal converted to a quaternary numerical signal prior to being input into the DNA-based microprocessor.

19. The DNA-based microprocessor of claim 16, wherein said DNA-transistors comprises a combination of one or more following transistor types: AND, OR, NOT, NAND, NOR, XOR or XNOR.

20. The DNA-based microprocessor of claim 16, wherein said input signal comprises more than one pulsed electromagnetic wave comprising at least two different frequencies, thereby allowing the DNA-based transistor to simultaneously process multiple sequences of data.
